(19) United States
(12) Patent Application Publication
(10) Pub. No.: US 2008/0025533 A1
(43) Pub. Date: Jan. 31, 2008

(54) Loudspeaker

(76) Inventors: David Livingstone, Royston The United Kingdom (GB); Richard Topliss, Trumpington The United Kingdom (GB); Mark Richard Shepherd, Royston The United Kingdom (GB)

Correspondence Address: NIXON & VANDERHYE, PC, 901 NORTH GLEBE ROAD, 11TH FLOOR, ARLINGTON, VA, 22203, US

(21) Appl. No.: 11/587,085

(22) PCT Filed: Apr. 21, 2005
(86) PCT No.: PCT/GB05/01536

§ 371 Date: Jan. 10, 2007

(30) Foreign Application Priority Data
Apr. 22, 2004 (GB) 0408909.0
Feb. 25, 2005 (GB) 0503932.6

(51) Int. Cl. H04R 17/00

(52) U.S. Cl. 381/190

(57) ABSTRACT

A loudspeaker comprises the casing (22) of a portable electronic device, having mounted thereon a sound generating element (21) which may be a transparent cover for a display. The sound generating element (21) is driven to generate sound by a piezoelectric actuator (1) extending along a sector of a circle and coupled at one end (7) to the casing (22) by a first block (24) and at the other end (8) to the edge (26) of the sound generating element (21) by a second block (25). The first block (24) and the second block (25) each have stop surfaces spaced apart from each other and capable of engaging each other to limit the amount of relative movement of the ends (7) and (8) of the actuator (1) to prevent damage to the actuator (1). The sound generating element (21), the first and second blocks (24) and (25) and the actuator (1) form an assembly which may be manufactured for subsequent assembly to the casing (22).

This invention relates to a loudspeaker which is particularly suitable for use in an electronic device of relatively small size as to be portable, such as a mobile phone, Personal Digital Assistant (PDA) or lap-top computer.

An example of a type of loudspeaker suitable for use in a portable electronic device is described in WO-03/001841. This type of loudspeaker is referred to herein as a “C-Window speaker” and comprises a sound generating element (diaphragm) driven by a “C-morph actuator”, which is a piezoelectric actuator having a bender construction and shaped as a cylinder with a sector removed (hence it is C-shaped in cross-section). One end of the actuator is attached to the sound generating element while the other end of the actuator is attached to the housing of the electronic device. In operation the ends of the actuator relatively rotate. Thus, the actuator is operable to drive motion of the sound generating element including a component of rotation. The C-Window speaker allows a panel in the housing of various products, such as mobile phones and PDAs, to be driven as a loudspeaker, and provides the following advantages:
the speaker is very low profile, so does not take up much room inside the product;
the C-morph actuator looks electrically like a capacitor, and consumes little power;
for products that use a display, such as mobile phones, the sound generating element may be a polycarbonate screen as currently used to protect the LCD;
use of such loudspeakers allows the product to be more effectively sealed against water and dust;
the sound produced is diffuse, preventing hearing damage if used at loud volume close to the ear;
the sound quality is superior to equivalent sized speakers; and
the parts and construction of the speaker are simple, potentially yielding cost advantages over traditional speakers.

However, the C-window speaker and other loudspeakers employing a piezoelectric actuator introduce a number of problems in manufacture, as follows. In particular, conventional loudspeakers driven by a voice-coil are self-contained and can be mounted in the housing of the electronic device (such as mobile phone) by simple glueing or mechanical fixing. Also, such voice-coil loudspeakers can be tested before being assembled into the product. In contrast, loudspeakers employing a piezoelectric actuator such as the C-window speaker require a more complex procedure for assembly into the product, as both the edges of the sound generating element and the fixed end of the actuator need to be fixed to the housing. Also, the loudspeaker cannot be pre-tested as it does not operate as a speaker until fixed to the casework.

Another issue with the C-window speaker and other loudspeakers employing a piezoelectric actuator is that the actuator is vulnerable to over-stressing in use when an externally applied force, for example when the sound generating element is accidentally poked, dropped or compressed, causes the sound generating element to be moved relative to the support structure. Since the two ends of the actuator are fixed to the sound generating element and the support structure respectively, such an event can over-stress the actuator, causing damage and possibly failure of the actuator. This is a particular problem in a portable electronic device which is liable to be treated carelessly.

According to a first aspect of the present invention, there is provided a loudspeaker comprising:

a support structure;

a sound generating element mounted on the support structure;

a piezoelectric actuator arranged to provide, on activation, relative movement between two ends of the actuator; and

a first block and a second block coupled to respective ends of the actuator, the first block being coupled to the support structure and the second block being coupled to the sound generating element so that said relative movement of the ends of the actuator is capable of driving movement of the sound generating element to generate sound, wherein the first block and the second block each have at least one stop surface, which stop surfaces of the first block and the second block are spaced apart from each other so as to be capable of engaging each other to limit the amount of relative movement of the ends of the actuator to prevent damage to the actuator.

This arrangement for the loudspeaker provides advantages in assembly. In particular, it is possible to manufacture a loudspeaker assembly consisting of the first and second blocks and the actuator, and optionally also the sound generating element, separately from the final stage of mounting the assembly to the support structure. Thus the manufacture of the loudspeaker assembly may be done by a component manufacturer who has particular expertise in the handling and processing of piezoelectric materials. The loudspeaker assembly may then be supplied to a device manufacturer who mounts the assembly to the support structure, including coupling of the second block to the support structure. As it is not necessary to bond the piezoelectric actuator directly to the support structure, this is easily achieved without particular expertise in the bonding of piezoelectric materials.

These advantages are felt particularly where the support structure is a portion of a housing of an electronic device, for example a transparent cover for a display. In such a case, the manufacturer of the electronic device is typically assembling large numbers of different types of components and desires simple manufacture, for example by dropping functional sub-assemblies into the housing. The present invention meets this requirement in respect of a loudspeaker integrated into the housing, because the assembly may be mounted without the need to fix the piezoelectric actuator to the housing.

As the loudspeaker assembly may be provided separately from the support, according to a second aspect of the present invention, there is provided a loudspeaker assembly comprising: a sound generating element capable of being mounted on a support structure; a piezoelectric actuator arranged to provide, on activation, relative movement between two ends of the actuator; and a first block and a second block coupled to respective ends of the actuator, the first block being capable of being coupled to the support structure and the second block being capable of being coupled to a sound generating element which is capable of being mounted on a support structure so that said relative movement of the ends of the actuator is capable of driving movement of the sound generating element to generate sound, wherein the first block and the second block each have at least one stop surface, which stop surfaces of the first block and the second block are spaced apart from each other so as to be capable of engaging each other to limit the amount of relative movement of the ends of the actuator to prevent damage to the actuator. The loudspeaker assembly may further comprise the sound generating element coupled to the sound block.

In accordance with the first and second aspects of the present invention, the first block and the second block each have at least one stop surface which stop surfaces of the first block and the second block are spaced apart from each other so as to be capable of engaging each other to limit the amount of relative movement of the ends of the actuator to prevent damage to the actuator. Thus the first and second blocks are utilised to prevent damage to the actuator caused when an externally applied force causes the sound generating element to be moved relative to the support structure. Using the first and second blocks which in themselves provide manufacturing advantages to also protect the actuator provides the advantage that it is not necessary to provide separate elements for this purpose, for example stops provided elsewhere in the loudspeaker.

Advantageously, the first block and the second block each have a plurality of stop surfaces, which stop surfaces of the first block and the second clock extend in different directions so that they are capable of engaging each other to limit the amount of relative movement of the ends of the actuator in three dimensions. This provides the advantage that the prevention of damage to the actuator is achieved whatever the orientation of the applied force. This is important because electronic devices are typically subjected during normal use to applied forces of a wide range of type and nature, particularly as electronic devices become smaller and more portable.

That being said, it is not essential to provide the first block and the second block with the stop surfaces and accordingly in accordance with a third aspect of the present invention, there is provided a loudspeaker comprising:

a support structure;

a sound generating element mounted on the support structure;

a piezoelectric actuator arranged to provide, on activation, relative movement between two ends of the actuator; and

a first block and a second block coupled to respective ends of the actuator, the first block being coupled to the support structure and the second block being coupled to the sound generating element so that said relative movement of the ends of the actuator is capable of driving movement of the sound generating element to generate sound.

The present invention is generally applicable to any type of piezoelectric actuator but has particular advantage when applied to an actuator which extends between the two ends in a curve, for example a sector of a circle, and in which the actuator has a bender construction, for example a “C-morph actuator” as described in WO-03/001841. The present invention also has particular advantage when applied to an actuator which comprises ceramic piezoelectric material, because such material is susceptible to damage when over-stressed.

For ease of manufacture, preferably the first and second blocks are each a single piece of material but either or both block may alternatively be formed from several pieces of material.

To allow a better understanding, embodiments of the present invention will now be described by way of non-limitative example, with reference to the accompanying drawings, in which:

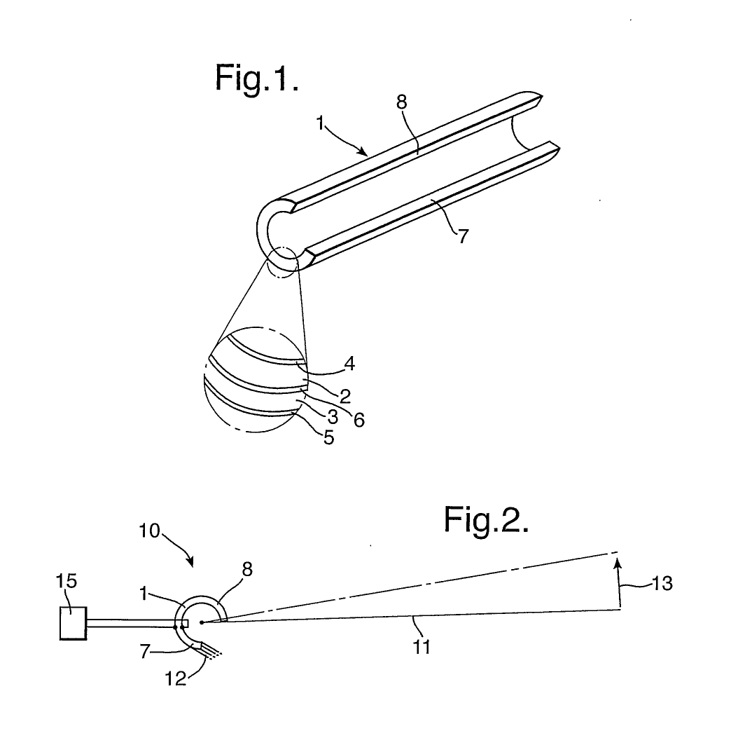

FIG. 1 is a perspective view of a C-morph actuator including a detailed view of the layered construction;

FIG. 2 is a schematic side view of a loudspeaker using the actuator of FIG. 1;

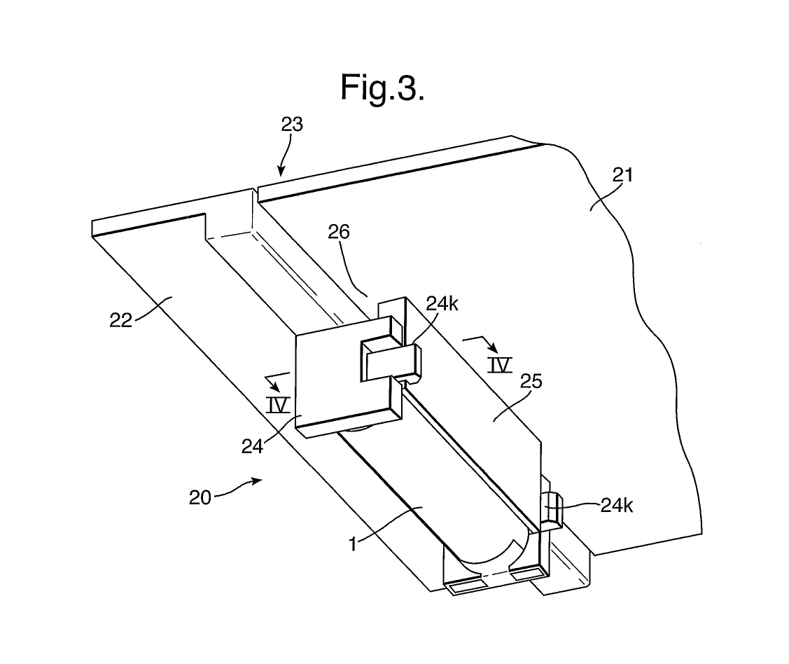

FIG. 3 is a perspective view of a first loudspeaker;

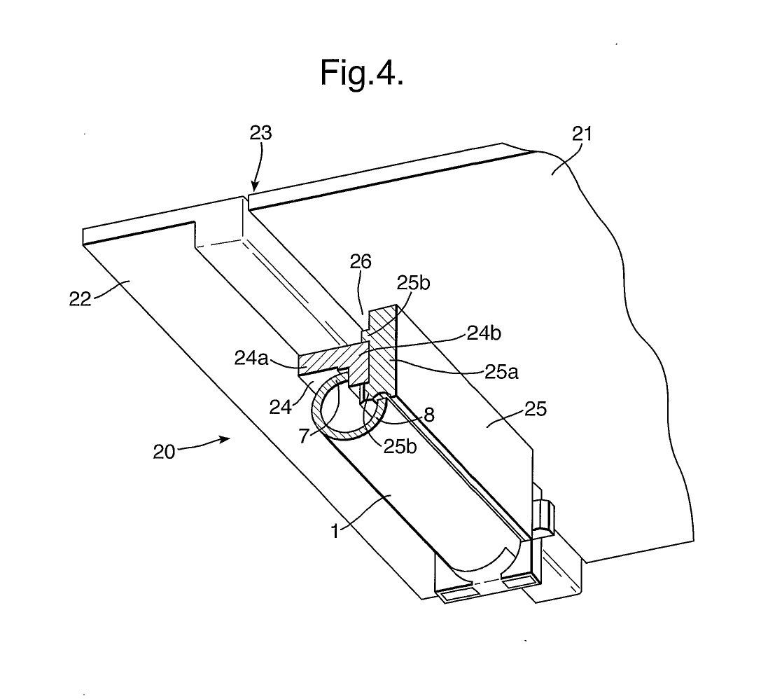

FIG. 4 is a perspective view of the first loudspeaker of FIG. 3, but with the actuator and the blocks to which it is coupled shown cut away along line IV-IV in FIG. 3;

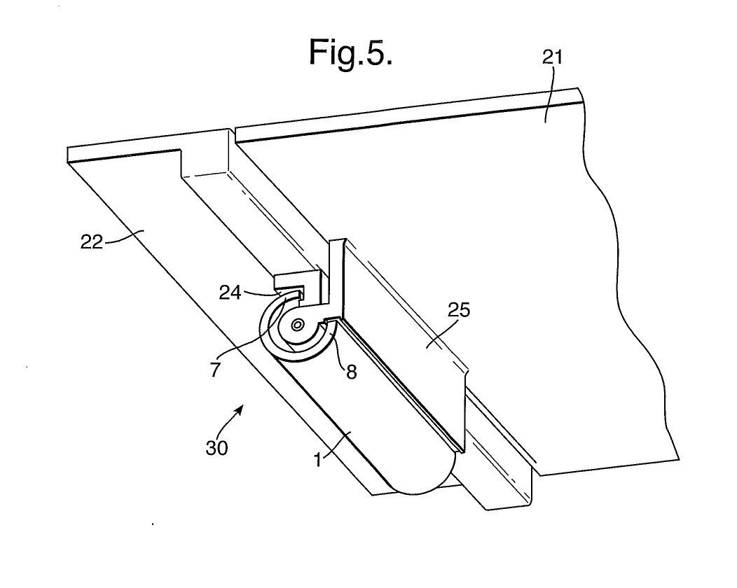

FIG. 5 is a perspective view of a second loudspeaker;

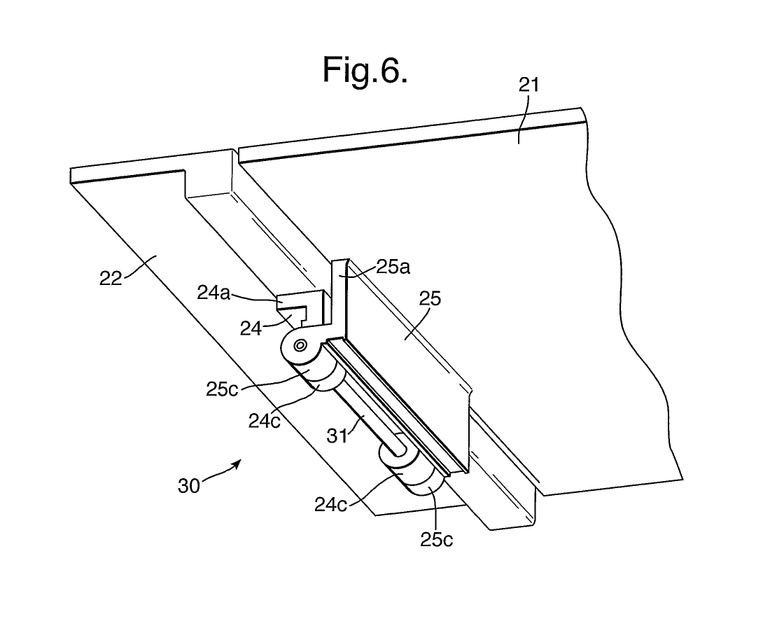

FIG. 6 is a perspective view of the second loudspeaker of FIG. 5 without the actuator;

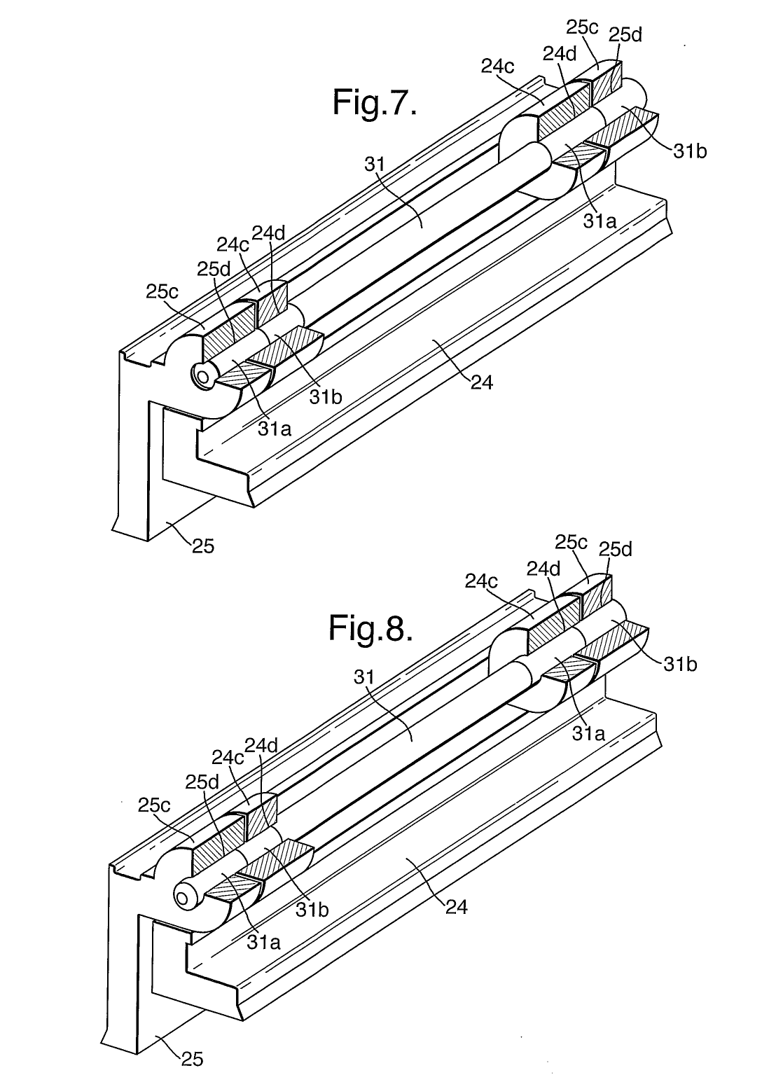

FIG. 7 is a perspective view of first and second blocks of the second loudspeaker of FIG. 5 without the actuator and with a portion cut away;

FIG. 8 is a perspective view corresponding to that of FIG. 7 but on movement of a pin;

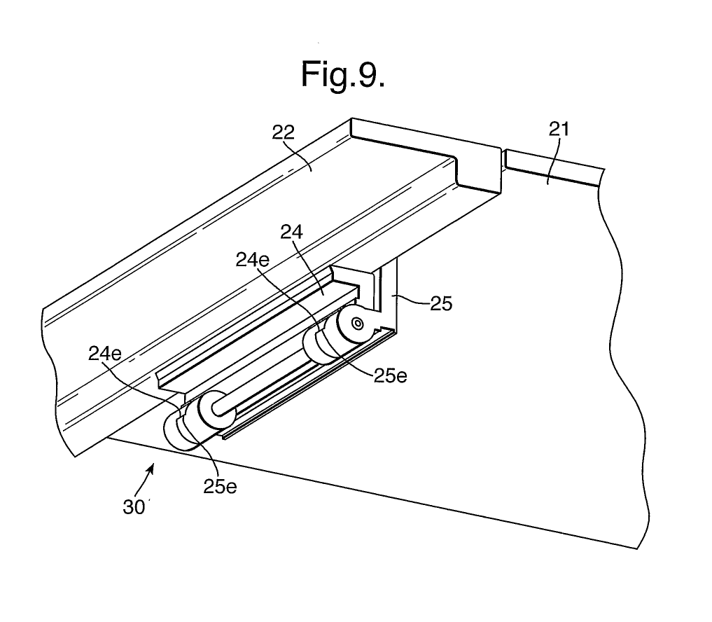

FIG. 9 is a perspective view of the second loudspeaker of FIG. 5 from a different angle;

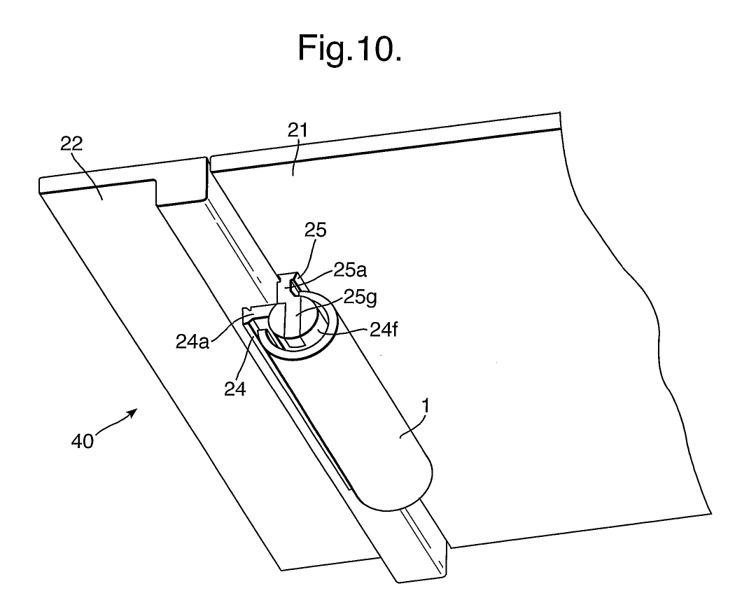

FIG. 10 is a perspective view of a third loudspeaker;

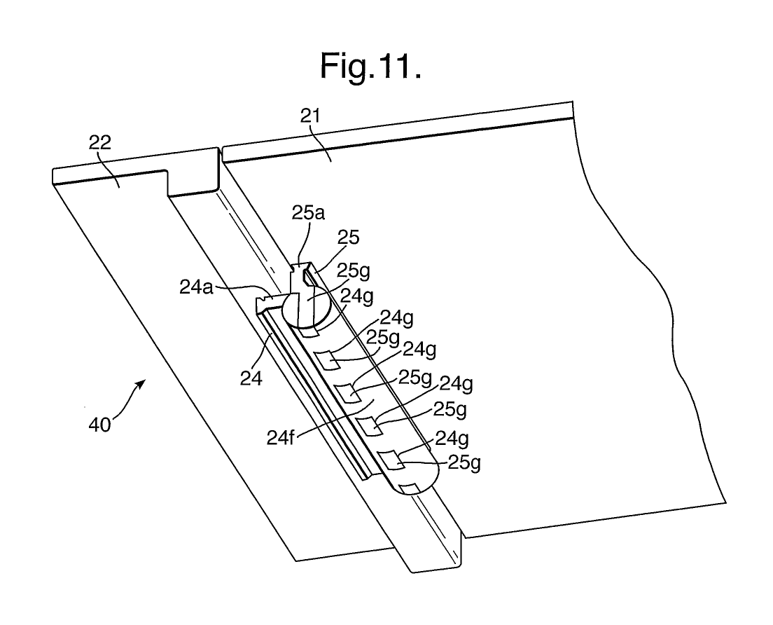

FIG. 11 is a perspective view of the third loudspeaker of FIG. 10 without the actuator;

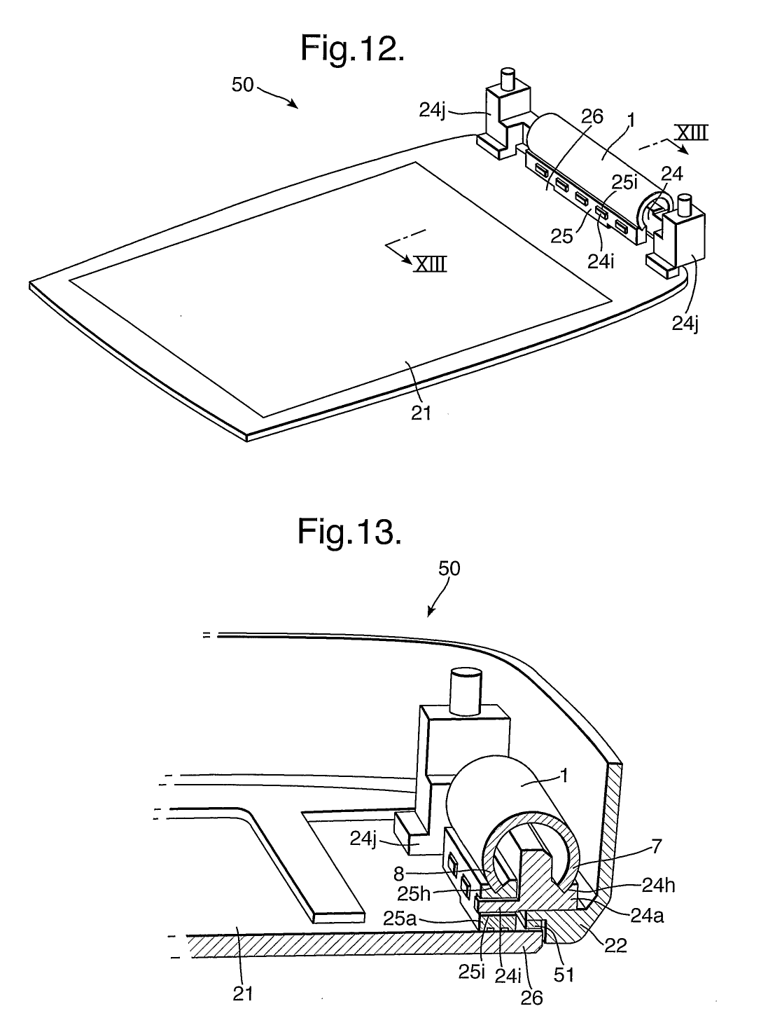

FIG. 12 is a perspective view of the loudspeaker assembly of a fourth loudspeaker;

FIG. 13 is a perspective view of the fourth loudspeaker cut away along line XIII-XIII in FIG. 12;

FIG. 14 is a perspective view of the casing of a fifth loudspeaker from above;

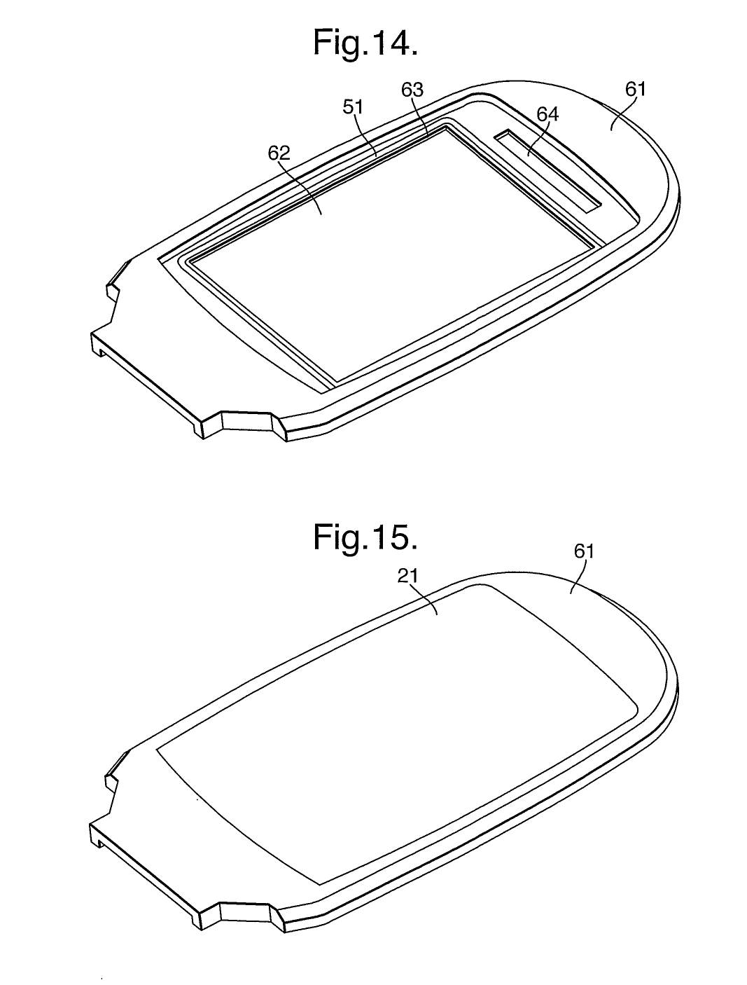

FIG. 15 is a perspective view of the casing of the fifth loudspeaker with the diaphragm coupled thereto;

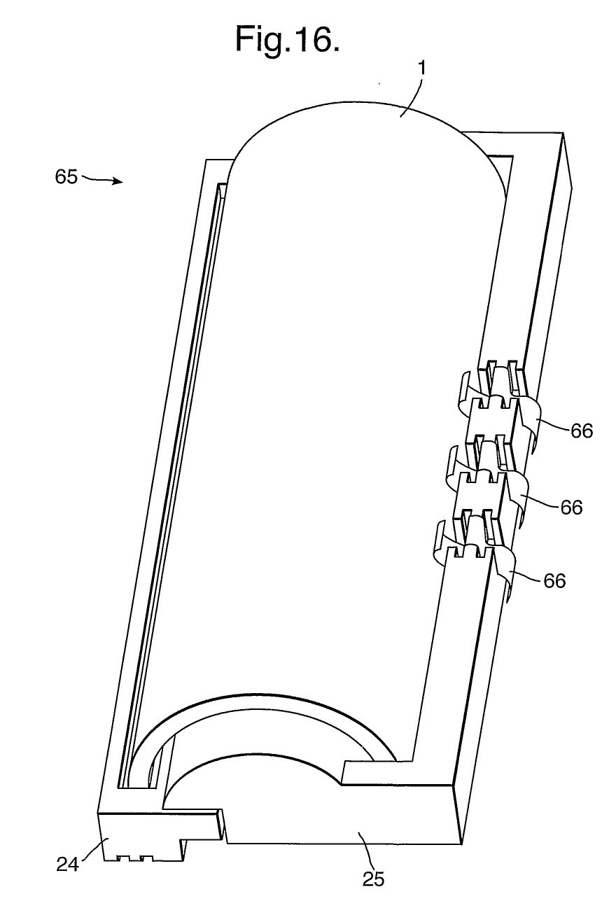

FIG. 16 is a perspective view of the loudspeaker assembly of the fifth loudspeaker;

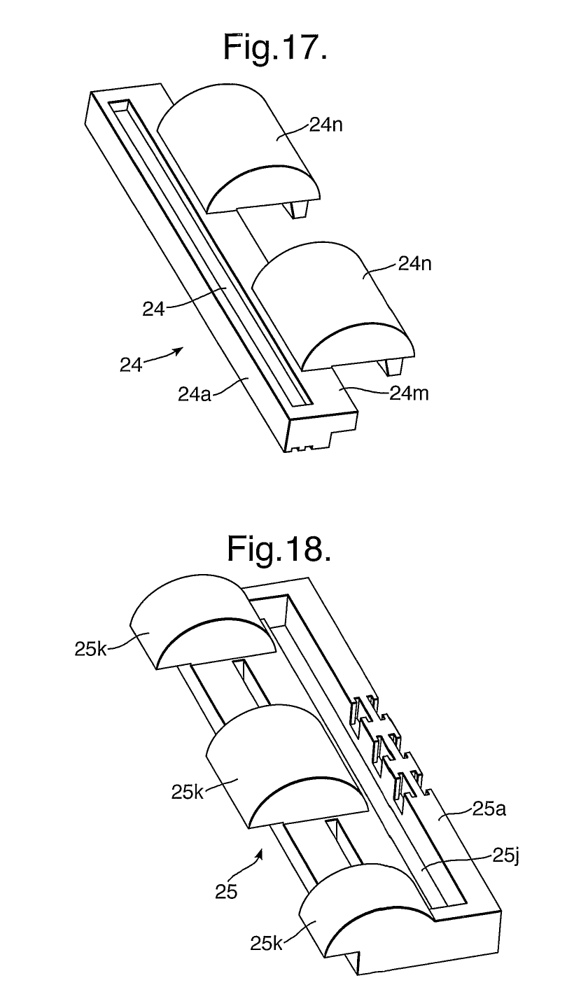

FIG. 17 is a perspective view of the first block of the loudspeaker assembly of the fifth loudspeaker;

FIG. 18 is a perspective view of the second block for the loudspeaker assembly of the fifth loudspeaker;

FIG. 19 is a perspective view from above of the first and second blocks of the fifth loudspeaker assembly when assembled, as shown in FIG. 16 but with the actuator omitted;

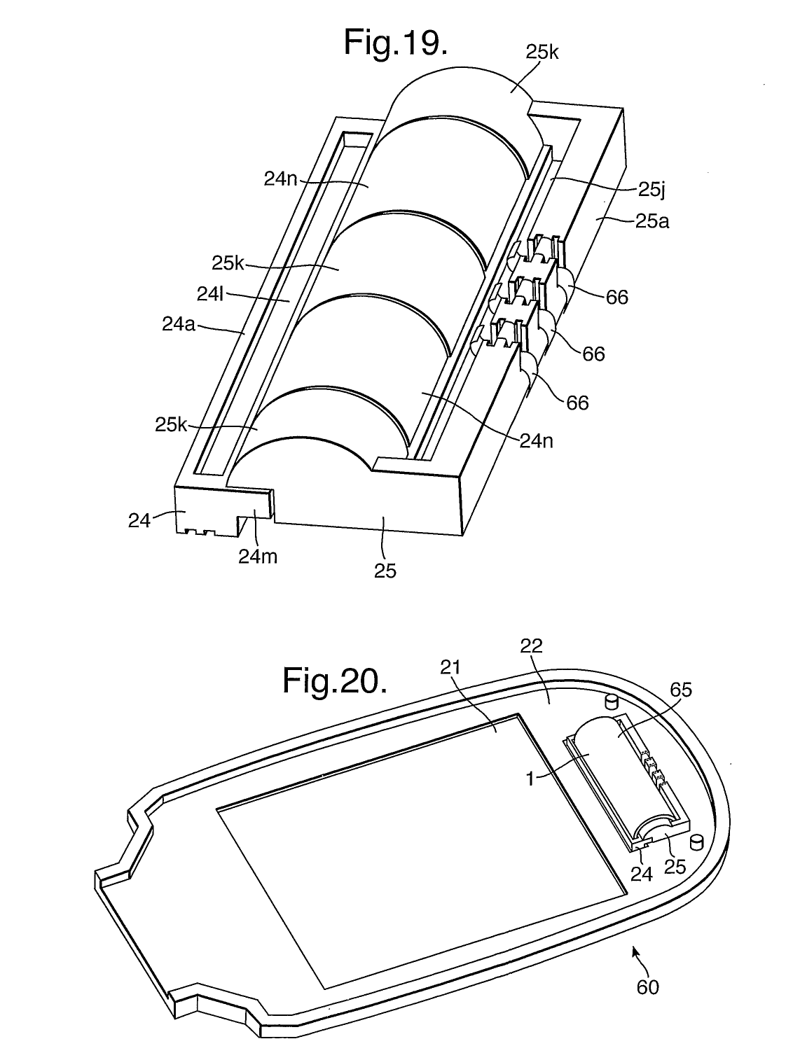

FIG. 20 is a perspective view of the fifth loudspeaker from below;

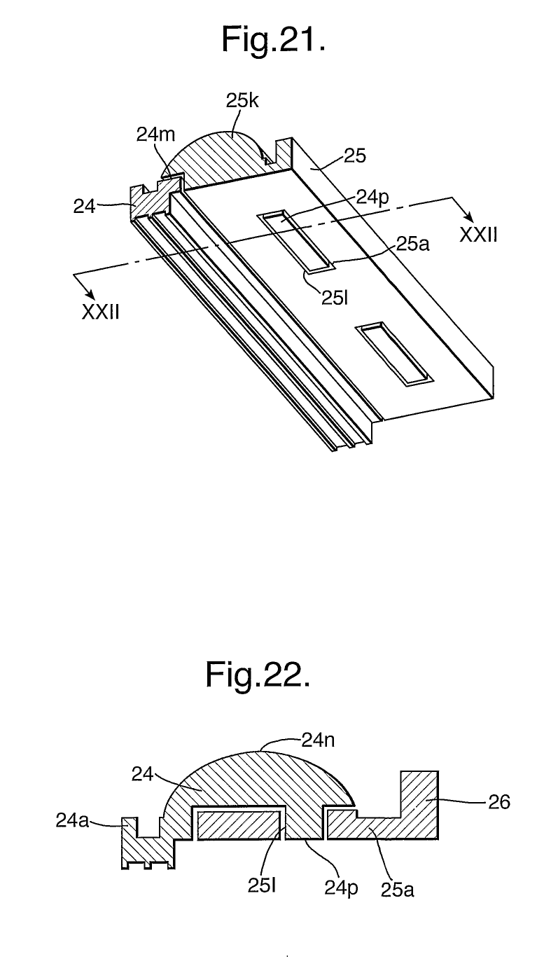

FIG. 21 is a perspective view from below of the first and second blocks of the fifth loudspeaker assembly when assembled, with the actuator omitted; and

FIG. 22 is a cross-sectional view of the first and second blocks of the fifth loudspeaker assembly taken along line XXII-XXII in FIG. 21.

There will first be described an actuator 1 as shown in FIG. 1. The actuator 1 has a bimorph bender construction comprising two layers 2 and 3 of piezoelectric material in a layered construction interposed between two outer electrodes 4 and 5 and a central electrode 6. The piezoelectric material of the layers 2 and 3 is preferably a piezoelectric ceramic such as PZT. The layers 2 and 3 of piezoelectric material are activated by application of a drive signal across the electrodes 4 to 6, the directions of poling and of the activation voltage being chosen so that layers 2 and 3 undergo a differential change in length, e.g. one layer 2 expanding while the other layer 3 contracts, thereby causing bending of the actuator 1. For example the layers 2 and 3 may be poled in the same direction and activated by a voltage in opposite directions by grounding the outer electrodes 4 and 5 and applying the voltage to the central electrode 6. Alternatively, the actuator 1 may have a multimorph bender construction comprising more than two layers of piezoelectric material.

The actuator 1 extends in a curve between two ends 7 and 8, in particular a sector of a circle, in this case about ¾ of a complete circle. Thus the actuator 1 is tubular in form. With this form, bending of the actuator 1 on activation causes relative displacement of the two ends 7 and 8, the displacement including a component of rotation about the axis around which the actuator curves.

In general, the actuator 1 may be of any size, but typical dimensions are a diameter of 5 mm, a thickness of 0.4-0.7 mm and a transverse length of 20 mm.

As an alternative to the bimorph bender construction shown in FIG. 1, the actuator 1 may have a multimorph bender construction comprising a large number of layers of piezoelectric material with intermediate electrodes, The actuator 1 is elongate in the sense that its transverse extent along the axis about which the actuator is curved is greater than its extent between the two ends 7 and 8, that is around the curve of the actuator 1. This increases the rigidity of the coupling between each end 7 and 8 of the actuator 1 and other components (as described below) and also increases the force applied for an actuator 1 having a given extent between its two ends 7 and 8.

FIG. 2 is a schematic diagram illustrating the operation of the actuator 1 in a loudspeaker 10 of the known type disclosed in WO-03/001841 and described above referred to as a C-Window. In this case, the actuator 1 is mechanically coupled to a diaphragm 11 to drive movement of the diaphragm 11 to generate sound so that the diaphragm 11 acts as a sound generating element. The first end 7 of the actuator 1 is mechanically coupled to a support structure 12 and is therefore fixed. The second end 8 of the actuator 1 is rigidly coupled to the diaphragm 11. When activated, the second end 8 of the actuator 1 moves relative to the first end 7 which is fixed, thereby driving the diaphragm 11. The movement of the diaphragm 11 is shown schematically as a rotation by the arrow 13, although in fact there is some bending of the diaphragm 11.

The loudspeaker 10 further comprises a drive circuit 15 for supplying a drive signal to the actuator 1 for driving the diaphragm 11 to generate sound.

There will now be described several loudspeakers which employ an actuator 1 as described above and are of the same type as the loudspeaker 10 of FIG. 2. These loudspeakers have the same basic construction. For clarity, where the loudspeakers have a common construction and operation, common elements will be given the same reference numerals and a description thereof will not be repeated.

A first loudspeaker 20 is shown in FIG. 3.

The first loudspeaker 20 has a diaphragm 21 which acts as a sound generating element. The diaphragm 21 is formed as a flat panel of material. The diaphragm 21 is mounted to the casing 22 of a portable electronic device such as a mobile telephone, which casing 22 acts as a support structure for the loudspeaker 20. FIG. 3 is a view from the inside of the casing 22. The diaphragm 21 covers an aperture 23 in the casing 22 and may therefore be considered as a part of the casing 22. The diaphragm 21 is transparent and forms the cover for a display device housed in the casing 22. The diaphragm 21 may be mounted to the casing by a seal member (not shown) extending around the periphery of the diaphragm 21.

The actuator 1 is coupled between the diaphragm 21 and the casing 22. In particular, the actuator 1 is coupled indirectly to the diaphragm 21 and the casing 22 by a first block 24 and a second block 25, respectively. This is best seen in the cut-away view of FIG. 4.

The first end 7 of the actuator 1 is coupled by a side surface of the actuator 1 to the first block 24 which is itself coupled to the casing 22. The couplings between the actuator 1 and the first block 24 and between the first block 24 and the casing 22 may be provided by a suitable adhesive which provides rigidity. The second end 8 of the actuator 1 is coupled to the second block 25 which is itself coupled to the diaphragm 21.

The second end 8 of the actuator 1 is coupled to the second block 25 by the end surface of the actuator 1 which faces the diaphragm 21 so that the main component of the motion driven by the actuator 1 is perpendicular to the plane of the diaphragm 21. The couplings between the second end 8 of the actuator 1 and the second block 25 and between the second block 25 and the diaphragm 21 maybe provided by a suitable adhesive which provides rigidity. The second block 25 is coupled to the edge 26 of the diaphragm 21.

The diaphragm 21, the actuator 1 and the first and second blocks 24 and 25 can be manufactured together as a loudspeaker assembly before the final stage of mounting the loudspeaker assembly to the casing 22. This is advantageous in manufacture as the loudspeaker assembly can be manufactured independently, for example by a manufacture with particular expertise in the field of piezoelectric materials, and can immediately undergo some form of performance testing. Subsequent mounting of the loudspeaker assembly to the casing 22 is a simple manufacturing operation as it is straightforward to position the loudspeaker assembly on the inside of the casing 22 and to couple the first portion 24 and, if provided, the seal member to the casing 22. This makes the assembly operation very similar to operations currently used in the assembly of portable electronic devices. In particular, there is no need to mount the diaphragm 21 to the casing 22, and then couple the actuator 1 to both the diaphragm 21 and the casing 22.

The actuator 1, on activation, drives motion of the edge 26 of the diaphragm 21 to which it is coupled, this motion including a component of rotation at that edge 26. The material and dimensions of the diaphragm 21 are selected to provide an appropriate level of stiffness for the diaphragm 21 to move the adjacent air to create sound and for providing adequate protection for the display device. Despite this, the diaphragm 21 may have some flexibility which allows it to flex in operation. For example, the diaphragm 21 may be made from a polycarbonate of the same type as is commonly used as a protective cover for a display device.

The form of the first and second blocks 24 and 25 will now be described.

Each of the first and second blocks 24 and 25 are formed as a single piece of material, for example a plastics material, although this is not essential. The first and second blocks 24 and 25 may be moulded.

The first and second blocks 24 and 25 are shaped as described in more detail below to provide each of the first and second block 24 and 25 with a plurality of stop surfaces which face one another and are spaced apart so that in the event of relative movement of the first and second block 24 and 25, the stop surfaces engage one another to limit the amount of relative movement of the first and second blocks 24 and 25 and hence also to limit the relative movement of the ends 7 and 8 of the actuator which are coupled to the first and second blocks 24 and 25. The purpose of the stop surfaces is to prevent damage to the actuator 1 by over-stressing the actuator 1 when the loudspeaker 20 is subject to an external force which moves the diagram 21 relative to the casing 22.

The first block 24 comprises a body portion 24a arranged between the actuator 1 and the casing 22, extending along the entire axial length of the actuator 1. On the interior side of the body portion 24a, the first block 24 has a stop portion 24b which protrudes inwardly towards the diaphragm 21, as best seen in FIG. 4. In addition, the first block 24 has a pair of catches 24k as best seen in FIG. 3, the catches 24k are arranged on each end of the first block 24 outside the actuator 1. The catches 24k protrude inwardly towards the diaphragm 21 to a greater extent than the stop portion 24b and are described further below.

The second block 25 comprises a body portion 25a arranged between the diaphragm 21 and the actuator 1, extending along the entire axial length of the actuator 1. On the outer side of the body portion 25a, the second block 25 has a pair of stop protrusions 25b arranged on opposite sides of the stop portion 24b of the first block 24. The facing surfaces of the stop portion 24b of the first block 24 and the stop protrusions 25b of the second block 25 are spaced apart from each other and act as stop surfaces which are capable of engaging one another to prevent relative movement of the first and second blocks 24 and 25 in a direction perpendicular to the plane of the diaphragm 21. In addition, the surface of the stop portion 24b on the interior side of the first block 24 faces and is spaced apart from the surface of the body portion 25b on the exterior side of the second block 25 so that these two surface act as stops surfaces which are capable of limiting relative movement of the first and second blocks 24 and 25 towards each other parallel to the plane of the diaphragm 21.

Furthermore, as seen in FIG. 3, the catches 24k extend inwardly along the sides of the body portion 25b of the second block 25 and extend around the interior side surface of the body portion 25a of the second block 25. Thus the facing surfaces of the two catches 24k and the body portion of 25a of the second block 25 are spaced apart from each other and act as stop surfaces which are capable of engaging one another to limit relative movement of the first and second blocks 24 and 25 firstly in a sideways direction, that is along the axial length of the actuator 1 and secondly in a direction parallel to the plane of the diaphragm 21 when the first and second blocks 24 and 25 move apart.

In summary, the various stop surfaces just described which are formed on the stop portion in 24b and the catches 24k of the first block 24 and on the body portion 25a and the stop protrusion 25b of the second block 25 are together capable of engaging to limit relative movement of the first and second blocks 24 and 25 in all three dimensions.

The spacing between the various stop surfaces on the first and second blocks 24 and 25 are chosen as follows to allow relative movement of the ends 7 and 8 of the actuator 1 to the drive normal movement of the diaphragm 21, but to limit that relative movement to prevent damage to the actuator 1.

To prevent an amount of relative movement of the ends 7 and 8 of the actuator 1 which could damage the actuator 1, the gaps between the various stop surfaces of the first and second blocks 24 and 25 are typically at most 400 μm, preferably at most 200 μm.

For a typical actuator 1, the relative displacement of the ends 7 and 8 of the actuator in a direction perpendicular to the plane of the diaphragm 21 is a maximum of 20 μm from the unactivated position. Accordingly, the spacing between the stop surfaces which extend parallel to the plane of the diaphragm 21 and limit relative movement perpendicular to the plane of the diaphragm 21, being in the first loudspeaker the stop surfaces formed between the facing surfaces of the stop portion 24b and the stop protrusions 25b, is usually at least 50 μm, preferably at least 100 μm. The spacing between the other stop surfaces of the first and second blocks 24 and 25 may be lower in that they extend generally perpendicular to the plane of the diaphragm 21 and so only need to provide clearance for the normal relative movement of the first and second blocks 24 and 25 in this direction. Such a spacing is typically at least 10 μm or at least 20 μm.

There will now be described further loudspeakers having the same construction as the first loudspeaker 20 of FIG. 3, except that the first block 24 and the second block 25 have a different form to provide stop surfaces which are capable of engaging each other to limit the amount of relative movement of the ends 7 and 8 of the actuator 1. For brevity, in respect of common elements the same reference numerals will be used and a description thereof will not be repeated. The above comments about the size and effect of the gap between the various stop surface between the first block 24 and the second block 25 apply equally to the stop surfaces of the further loudspeakers.

A second loudspeaker 30 is illustrated in FIG. 5, and also FIG. 6 in which the actuator 1 is not shown. The first and second blocks 24 and 25 are shown in greater detail in FIGS. 7 and 8 in which the stop collars 24c and 25c described below are shown cut away.

In the second loudspeaker 30, the first block 24 is provided with a pair of stop collars 24c protruding from the body portion 24a at different positions along the length of the actuator 1. The stop collars 24c each have a cylindrical aperture 24d, the cylindrical apertures 24d being arranged coaxially with each other. Inside the cylindrical aperture 24d, the first block 24 is provided with a pin 31 which is slidable axially along the cylindrical apertures 24d between the positions shown in FIGS. 7 and 8. The portions 31a of the pin 31 which are adjacent the cylindrical apertures 24d of the first block 24 over the entire range of movement of the pin 31 have an outer surface of the same size as the cylindrical apertures 24. Thus the pin 31 cannot move radially inside the apertures 24d at any point in the range of movement of the pin 31 between the positions shown in FIGS. 7 and 8.

The second block 25 also has a pair of stop collars 25c having a similar configuration to the stop collars 24c of the first block 24. In particular, the stop collars 25c of the second block 25 each have a cylindrical aperture 25d arranged coaxially with each other and coaxially with the cylindrical apertures 24d of the first block 24. The stop collars 25c of the second block 25 are arranged adjacent to the stop collars 24c of the first block 24 with the pin 31 extending through the cylindrical apertures 25d. The portions 31b of the pin 31 which are adjacent the respective stop collars 25c of the second portion 25 over the range of movement of the pin 31 are each tapered. These tapered portion 31b of the pin taper from a size and shape equal to that of the cylindrical apertures 25d of the second portion 25 to a smaller size, so that in the position of the pin 31 shown in FIG. 7 the pin 31 engages the stop collar 25c of the second block 25 but in the position shown in FIG. 8 the pin 31 is spaced from the stop collar 25c of the second block 25 with an annular gap therebetween.

Thus, when the pin 31 is in the first position shown in FIG. 7, the pin 31 engages both the stop collar 24c of the first block 24 and the stop collar 25c of the second block 25, thereby preventing relative motion of the first block 24 and the second block 25. Hence this is an inoperative state in which the ends 7 and 8 of the actuator 1 are prevented from moving relative to each other.

On the other hand, when the pin 31 is moved to the second position shown in FIG. 8, the annular gap between the pin 31 and the stop collar 25c of the second block 25 means that the outer surface of the tapered portion 31b of the pin 31 and the internal surface of the cylindrical apertures 25d in the second block 25 constitute stop surfaces which are capable of engaging each other to limit the amount of relative movement of the ends 7 and 8 of the actuator 1. In particular, the stop surfaces are capable of limiting the relative movement of the first and second blocks 24 and 25 in all directions perpendicular to the pin 31, i.e. parallel to the axis around which the actuator 1 is curved. Thus, this is an operational state in which the ends 7 and 8 of the actuator 1 may be moved, but in which the actuator 1 is protected from being over stressed by an externally applied force.

The loudspeaker assembly consisting of the diaphragm 21, the actuator 1 and the first and second blocks 24 and 25 is manufactured in the inoperative state with the pin 31 in the position shown in FIG. 7. This prevents damage to the actuator 1 during any storage and transport before the loudspeaker assembly is mounted to the casing 22. On subsequent mounting of the loudspeaker assembly to the casing 22, the loudspeaker 20 is put in the operational state by moving the pin 31 to the position shown in FIG. 8.

The stop collars 24c and 25c are also capable of engaging to limit transverse and rotational movement of the diaphragm 21 relative to the casing 22.

Firstly, each one of the stop collars 24c of the first block 24 is arranged adjacent one of the stop collars 25c of the second block 25 with the facing surfaces of the stop collars 24c and 25c being spaced apart from each other to act as stop surfaces capable of limiting the amount of transverse movements of the ends 7 and 8 of the actuator 1, that is parallel to the axis around which the actuator 1 is curved.

Secondly, as best seen in FIG. 9, the facing surfaces of the stop collars 24c and 25c are stepped to provide radially extending surfaces 24e and 25e on each of the stop collars 24c and 25c. The facing surfaces 24e and 25e are spaced apart from each other to act as stop surfaces capable of engaging each other to limit the amount of relative rotary movement of the ends 7 and 8 of the actuator 1 which might damage the actuator 1.

A third loudspeaker 40 is shown in FIGS. 10 and 11.

In the third loudspeaker 40, the first block 24 comprises a body portion 24a having a cylindrical portion 24f arranged on the internal side of the body portion 24a. The cylindrical portion 24f is formed with a plurality of apertures extending therethrough in a direction perpendicular to the plane of the diaphragm 21. The third loudspeaker 40 is shown as having six apertures 24g of square cross-section, but in principle there could be any number of apertures 24g of any cross-sectional shape.

The second block 25 comprises a body portion 25a having a plurality of fingers 25g each extending through a respective one of the apertures 24g in the cylindrical portion 24f of the first block 24. The fingers 25g have the same shape as the apertures 24g, but are of slightly smaller dimensions than the apertures 24g so that the external surfaces of the fingers 25g and the internal surfaces of the apertures 24g are spaced apart from each other to act as stop surfaces capable of engaging each other to limit the amount of relative movement of the ends 7 and 8 of the actuator 1. In particular, the fingers 25g and the apertures 24g are capable of limiting the amount of relative movement of the first and second blocks 24 and 25 in all directions parallel to the plane of the diaphragm 21.

In addition, the body portion 24a of the first block 24 protrudes inwardly so as to overlap the body portion 25a of the second block 25. Accordingly, the uppermost surface of the body portion 24a of the first block 24 and the lowermost surface of the body portion 25a of the second block 25 face one another and are spaced apart to act as stop surfaces wlich are capable of engaging one another to limit relative movement of the first and second blocks 24 and 25 in a direction perpendicular to the plane of the diaphragm 21.

A fourth loudspeaker 50 is illustrated in FIGS. 12 and 13, FIG. 12 showing the loudspeaker assembly for mounting to the casing 22 and FIG. 13 being a cut-away view of the loudspeaker 50 as a whole.

In the fourth loudspeaker 50, the first block 24 has a body portion 24a having a groove 24h in which the first end 7 of the actuator 1 is seated with the end surface of the actuator 1 arranged at an angle of approximately 45° to the plane of the diaphragm 21. The first block 24 further has a plurality of fingers 24i on the inner side of the body portion 24a extending over the diaphragm 21 parallel to the plane of the diaphragm 21. The loudspeaker 50 is illustrated as having five fingers 24i of rectangular cross-section, but in general the first block 24 may have any number of fingers 24i of any cross-sectional shape.

The second block 25 comprises a body portion 25a having a groove 25h in which the second end 8 of the actuator 1 is seated to extend at an angle of approximately 45° to the plane of the diaphragm 21. The second block 25 further has a plurality of apertures 25i, each of the fingers 24i of the first block 24 extending through a respective aperture 25i of the second block 25. The apertures 25i have the same shape as the fingers 24i but are of slightly larger dimensions so that the inner surfaces of the apertures 25i and the outer surfaces of the fingers 24i are spaced apart from each other to act as stop surfaces capable of engaging each other to limit the amount of relative movement of the ends 7 and 8 of the actuator 1. Thus, the fingers 24i and the apertures 25i capable of limiting the amount of relative movement of the first and second blocks 24 and 25 firstly in a direction perpendicular to the plane of the diaphragm 21 and secondly in a direction parallel to plane of the diaphragm 21 and along the axis about which the actuator 1 is curved.

Furthermore, the surface of the body portion 24a on the inner side of the first block 24 (from which surface the fingers 24i protrude) faces and is spaced apart from the surface of the body portion 25a on the outer side of the second block 25 so that these surfaces act as stop surfaces which are capable of limiting the amount of relative movement of the first and second blocks 24 and 25 in a direction perpendicular to the plane of the diaphragm 21 with the first and second blocks 24 and 25 moving towards each other.

In addition, the first block 24 has two bridge portions 24j, one arranged at each end of the first block 24, beyond the ends of the actuator 1. The bridge portions 24j each extend from the body portion 24a of the first block 24 to the edge 26 of the diaphragm 21 of opposite sides of the second block 25 where the bridge portions 24j are coupled to the diaphragm 21. Thus, in use, the portion of the edge 26 of the diaphragm coupled to the bridge elements 24i is held fixed relative to the portion of the edge 26 of the diaphragm 21 coupled to the second block 25 which is driven to move by the actuator 1. This arrangement is advantageous, because it allows the loudspeaker assembly consisting of the diaphragm 21, the actuator 1 and the first and second blocks 24 and 25 to generate sound and be tested even before the loudspeaker assembly is mounted on the casing 22.

The loudspeaker 50 further has a seal member 51 extending around the periphery of the diaphragm 21. The seal member 51 is on the inner surface of the diaphragm 21, that is uppermost in FIGS. 12 and 13. Thus the second end 8 of the actuator 1 is coupled to the diaphragm 21 inside the seal member 51. The aperture 26 in the casing 22 is sized so that the diaphragm 21 overlaps the peripheral edge of the aperture 26. Around that peripheral edge of the aperture 26, the casing 21 is formed with a seat 52 recessed into the casing 22. The seal member 51 is seated on the seat 52 and coupled thereto by a suitable adhesive to mount the diaphragm 21 to the casing 22. In this manner the seal member 51 seals between the diaphragm 21 and the casing 22.

The nature of the seal member 51 will now be described. The seal member 51 is compliant and so the diaphragm 21 is free to move when driven by the actuator 1. The primary purpose of such a seal member is to act as a seal against ingress of fluids and particulates, for which is adequate a completely flexible piece of material which does not restrain the motion of the diaphragm 21. However, it is advantageous to use a material which provides some acoustic damping as this improves the flatness of the frequency response of the loudspeaker 50. The material of the seal member 51 may be foamed elastomer with high compliance (low stiffness), for example a polyurethane foam. For example, the Compression Force Deflection of the material of the seal member 51 is preferably in the range 25−500 kPa, more preferably 100-300 kPa (measured at 0.2 inches/minute strain rate and 25% deflection). The Durometer hardness on the Shore “A” scale is preferably in the range 8-45, more preferably about 25. An example of a suitable material for the seal member 51 is a polyurethane foam, for example a foam supplied under the name PORON (trade mark) by Rogers Corporation such as PORON 4701-40 Soft, preferably high density grade which has a density of 480 kg/m3, thickness 0.8 mm and typical Compression Force Deflection of 173 kPa and Shore “A” hardness of 25.

A fifth loudspeaker 60 will now be described with reference to FIGS. 14 to 20.

The fifth loudspeaker 60 comprises a casing 61 which acts as a support structure for the loudspeaker 60. The casing 61 is shown in FIG. 14 which is a view from above. The casing 61 has an overall shape allowing it to be used as part of the housing for a display in a conventional type of mobile telephone having a “clam shell” configuration. In such a configuration, the part of the housing mounting the display is hinged to the remainder of the mobile telephone in the manner of a clam shell so that in a closed state the display faces the keyboard inside the mobile telephone and in an open state both the keyboard and the display are accessible.

The casing 61 has an aperture 62 through which it is possible to view a display device (not shown) held in the assembled mobile telephone. The casing 61 has a lip 63 extending around the entire inner periphery of the aperture 62 and recessed so that the lip 63 is below the level of the outer surface of the casing 61.

As shown in FIG. 15, a diaphragm 21 formed as a flat panel of material is seated on the lip 63 and covers the aperture 62. The outer surface of the diaphragm 21 is flush with the outer surface of the casing 61 due to the recessing of the lip 63. As the diaphragm 21 covers the aperture 62, it may be considered as a part of the casing 61. The diaphragm 21 is transparent and forms a cover for the display device housed below the casing 61. A seal member 51 is seated on the lip 63 and coupled by a suitable adhesive between the diaphragm 21 and the lip 63 to provide sealing. The nature of the seal member 51 is as described above.

On one side of the aperture 62, the lip 63 has formed therein an elongate slot 64 through which the diaphragm 21 is driven as described further below.

Movement of the diaphragm 21 is driven by a loudspeaker assembly 65 incorporating an actuator 1. The loudspeaker assembly 65 is as shown in FIG. 16. The actuator 1 is constructed and arranged as described above except that the actuator 1 curves along a sector of a circle between the two ends 7 and 8 of the actuator 1 which is about half of a complete circle.

The loudspeaker assembly 65 includes a first block 24 to which the first end 7 of the actuator 1 is coupled and a second block 25 to which the second end 8 of the actuator 1 is coupled. The form of the first and second block 24 and 25 will now be described with reference to FIGS. 17 to 19, FIG. 17 being a view of the first block 24, FIG. 18 being a view of the second block 25 and FIG. 19 being a view of the first and second blocks 24 and 25 assembled together in the loudspeaker assembly 65 but omitting the actuator 1 for clarity.

The first block 24 comprises a body portion 24a extending along the entire axial length of the actuator 1. As described further below, the surface of the body portion 24a which is lowermost in FIGS. 17 and 19 is coupled to the diaphragm 21. The opposite surface the body portion 24a has a groove 24l in which the first end 7 of the aperture 1 is coupled to the first block 24. On the outside of the body portion 24a (to the right in FIGS. 16, 17 and 19), the first block 24 has a ledge 24m which protrudes away from the body portion 24a. The first portion 24 also has a pair of protrusions 24n formed on the upper surface of the ledge 24m (that is on the same surface as the groove 24l but outwardly of the groove 24l). The protrusions 24n protrude from the ledge 24m and each have a semi-circular shape with a flat lower surface in substantially the same plane as the upper surfaces of the ledge 24m and with a curved upper surface over which the actuator 1 extends.

The second block 25 comprises a body portion 25a having a groove 25j is formed in its upper surface. The second end 8 of the actuator 1 is coupled to the first block 25 in the groove 25j. The second block 25 is also provided with spring contacts 66 for making electrical contact with the actuator 1.

On the inner side of the second block 25 (to the left in FIGS. 16, 18 and 19), the second block 25 is formed with a plurality of protrusions 25k which have an identical cross-sectional shape to the protrusions 24n of the first block 24. The protrusions 25k of the second block 25 are formed on the upper surface of the body portion 25a with their flat surface substantially in the same plane as the upper surface of the body portion 25a so that the protrusions extend away from the body portion 25a. The curved surface of the protrusions 25k is uppermost with the actuator 1 extending therearound.

The protrusions 24n of the first block 24 and the protrusions 25k of the second block 25 are positioned at different positions along the axial length of the actuator 1 so that they alternate along the axial length of the actuator 1 as best seen in FIG. 19.

In addition, each protrusion 24n of the first block 24 has a projection 24p on its flat lower surface, which projections 24p extend along the respective protrusion 24n parallel to the axis about which the actuator 1 is curved. Each projection 24p fits within a respective aperture 25l formed in the body portion 25a of the second block 25.

Although the loudspeaker assembly 65 is shown as having two protrusions 24n on the first block 24 and three protrusions 25k on the second block 25, in general any number of protrusions 24n and any number of protrusions 25k may be provided.

As a result of this arrangement, the first and second blocks 24 and 25 have a number of facing surfaces which are spaced apart to act as stop surfaces, as follows.

Firstly, the flat lower surfaces of the protrusions 24n of the first block 24 face, and are spaced apart from, the upper surface of the body portion 25a of the second block 25 between the protrusion 25k to act as stop surfaces. Similarly, the flat lower surfaces of the protrusions 25k of the second block 25 face and are spaced apart from the flat upper surfaces of the ledge 24m of the first block 24 between the protrusions 24n to act as stop surfaces. These stop surfaces limit the relative movement of the first and second blocks 24 and 25 in a direction perpendicular to the plane of the diaphragm 21.

Secondly, the side surfaces of the protrusion 24m of the first block 24 and the protrusions 25k of the second block 25 face one another and are spaced apart to act as stop surfaces which limit the relative movement of the blocks 24 and 25 in a direction parallel to the plane of the diaphragm 21 and along the axis about which the actuator 1 is curved.

Thirdly, the outer surface of the ledge 24m of the first block 24 and the inner surface of the body portion 25a of the body 25 face one another and are spaced apart to limit relative movement of the blocks 24 and 25 towards one another in a direction parallel to the plane of the diaphragm 24 but perpendicular to the axis about which the actuator 1 is curved.

Fourthly, the sides of the projections 24p of the first block 24 and of the apertures 25l of the second block 25 face one another and are spaced apart to limit relative movement of the blocks 24 and 25 both towards one another and away from one another in a direction parallel to the plane of the diaphragm 24 but perpendicular to the axis about which the actuator 1 is curved.

Accordingly, the various stop surfaces of the first and second blocks 24 and 25 serve to limit the amount of relative movement of the first and second blocks 24 and 25 in three dimensions.

The loudspeaker assembly 65 as shown in FIG. 16 may be assembled independently of assembly of the remainder of the fifth loudspeaker 60 consisting of the casing 61 and the diaphragm 21 as shown in FIG. 15. The components of the loudspeaker assembly 65 may be assembled on a jig to obtain accurate alignment. Subsequently, the loudspeaker assembly 65 may be coupled to the casing 61 and diaphragm 21 to form the loudspeaker 60. In particular, the loudspeaker assembly 65 is coupled as shown in FIG. 20 which is a view of the casing 61 from below, that is in the opposite direction from FIGS. 14 and 15. In particular, the loudspeaker assembly 65 is positioned with the body portion 25a of first block 24 aligned with the aperture 64. Then, the body portion 24a of the first block 24 is coupled to the diaphragm 21 through the aperture 64 and the body portion 25a of the second block 25 is coupled to the casing 61.

1. A loudspeaker comprising:
a support structure;
a sound generating element mounted on the support structure;
a piezoelectric actuator arranged to provide, on activation, relative movement between two ends of the actuator; and
a first block and a second block coupled to respective ends of the actuator, the first block being coupled to the support structure and the second block being coupled to the sound generating element so that said relative movement of the ends of the actuator is capable of diving movement of the sound generating element to generate sound, wherein the first block and the second block each have at least one stop surface, which stop surfaces of the first block and the second block are spaced apart from each other so as to be capable of engaging each other to limit the amount of relative movement of the ends of the actuator to prevent damage to the actuator.

2. A loudspeaker according to claim 1, wherein the second block is coupled to the edge of the sound generating element.

3. A loudspeaker according to claim 2, wherein the first block is coupled to the Support structure outside the edge of the sound generating element.

4. A loudspeaker according to claim 2, wherein the first block has two bridge portions coupled to the edge of the sound generating element on opposite sides of the second block.

5. A loudspeaker according to claim 1, wherein the sound generating element is mounted on the support structure by a seal member extending around the periphery of a portion of the sound generating element, the second block being coupled to the sound generating element inside the seal member.

6. A loudspeaker according to claim 1, wherein one of the first block and the second block has a plurality of fingers extending through apertures in the other of the first block and the second block, the stop surfaces being surfaces of the fingers and internal surfaces of the apertures.

7. A loudspeaker according to claim 1, wherein the actuator extends between the two ends in a curve.

8. A loudspeaker according to claim 7, wherein said curve is a sector of a circle.

9. A loudspeaker according to claim 7, wherein the actuator is a sheet which is longer in extent along an axis about which the actuator is curved than in extent between the ends of the actuator.

10. A loudspeaker according to claim 1, wherein the actuator has a bender construction.

11. A loudspeaker according to claim 1, wherein the actuator comprises ceramic piezoelectric material.

12. A loudspeaker according to claim 1, wherein the stop surfaces of the first and second block are spaced apart from each other by at most 400 μm.

13. A loudspeaker according to claim 1, wherein the stop surfaces of the first and second block are spaced apart from each other by at most 200 μm.

14. A loudspeaker according to claim 1, wherein the stop surfaces of the first and second block are spaced apart from each other by at least 50 μm.

15. A loudspeaker according to claim 1, wherein the first block is a single piece of material.

16. A loudspeaker according to claim 15, wherein the second block is a single piece of material.

17. A loudspeaker according to claim 1, wherein the first block and the second block each have a plurality of stop surfaces, which stop surfaces of the first block and the second block extend in different directions so that they are capable of engaging one another to limit the amount of relative movement of the ends of the actuator in three dimensions.

18. A loudspeaker according to claim 1, wherein the support structure is a portion of a housing of an electronic device.

19. A loudspeaker according to claim 18, wherein the portion of a housing of an electronic device is a transparent cover for a display.

20. A loudspeaker assembly comprising:
a sound generating element capable of being mounted on a support structure;
a piezoelectric actuator arranged to provide, on activation, relative movement between two ends of the actuator; and
a first block and a second block coupled to respective ends of the actuator, the first block being capable of being coupled to the support structure and the second block being capable of being coupled to a sound generating element which is capable of being mounted on a support structure so that said relative movement of the ends of the actuator is capable of driving movement of the sound generating element to generate sound, wherein the first block and the second block each have at least one stop surface, which stop surfaces of the first block and the second block are spaced apart from each other so as to be capable of engaging each other to limit the amount of relative movement of the ends of the actuator to prevent damage to the actuator.

21. A loudspeaker assembly according to claim 20, further comprising a sound generating element capable of being mounted on a support structure, the second block being coupled to the sound generating element.

22. A loudspeaker comprising:
a support structure;
a sound generating element mounted on the support structure;
a piezoelectric actuator arranged to provide, on activation, relative movement between two ends of the actuator; and
a first block and a second block coupled to respective ends of the actuator, the first block being coupled to the support structure and the second block being coupled to the sound generating element so that said relative movement of the ends of the actuator is capable of diving movement of the sound generating element to generate sound.
